(19) United States
(12) Patent Application Publication
(10) Pub. No.: US 2025/0266689 A1
(43) Pub. Date: Aug. 21, 2025

(54) SYSTEMS OF PROVISIONING AN INTERFACE BETWEEN AN AC SYSTEM AND A DC SYSTEM

(71) Applicant: Infinity Miles, Inc., CUBA, MO (US)

(72) Inventors: Siavash Sadeghi, Irvine, CA (US); Pourya Shamsi, Rolla, MO (US)

(21) Appl. No.: 19/055,335

(22) Filed: Feb. 17, 2025

Related U.S. Application Data
(60) Provisional application No. 63/554,718, filed on Feb. 16, 2024.

(51) Int. Cl. H02J 5/00; H02J 7/00; H02M 1/00; H02M 3/335; H02M 7/493; H02M 7/5387

(52) U.S. Cl. CPC H02J 5/00; H02J 7/0013; H02M 1/0067; H02M 3/33573; H02M 3/33576; H02M 7/493; H02M 7/53871; H02J 2207/20

(57) ABSTRACT

The present disclosure provides a system of provisioning an interface between an AC system and a DC system. Further, the system may include an inverter device comprising two or more H-bridge inverters. Further, the two or more H-bridge inverters include a first H-bridge inverter and a second H-bridge inverter. Further, the first-primary positive terminal and the first-primary negative terminal of the first inverter may be connectable with the AC system and the second-primary positive terminal of the second inverter respectively. Further, the system may include two or more battery modules. Further, a first-secondary terminal of the first inverter and a second-secondary terminals of the second inverter is connected with a first battery module and a second battery module respectively. Further, each of the first-secondary terminals and the second-secondary terminals may be connected with the DC system.

### FIELD OF DISCLOSURE

The present disclosure generally relates to the field of electrical transmission or interconnection system. More specifically, the present disclosure related to the system of provisioning an interface between an AC system and a DC system.

### BACKGROUND

Currently, cascaded H-bridge inverters are combined with a dual-active bridge-isolated DC-DC converter to interface a medium-voltage grid with a low-voltage battery or charger system. This existing technique for facilitating interfacing is deficient with regard to several aspects. For instance, current technologies have risks associated with battery management, stability of a converter, and reliability of a system. Furthermore, current technologies incur higher power losses and cost of operation.

Therefore, there is a need for systems of provisioning an interface between an AC system and a DC system, that may overcome one or more of the above-mentioned problems and/or limitations.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a system of provisioning an interface between an AC system and a DC system. Further, the system may include an inverter device. Further, the inverter device includes two or more H-bridge inverters. Further, the two or more H-bridge inverters include a first H-bridge inverter and a second H-bridge inverter. Further, the first H-bridge inverter may include a first-primary terminal comprising a first-primary positive terminal and a first-primary negative terminal. Further, the second H-bridge inverter may include a second-primary terminal comprising a second-primary positive terminal and a second-primary negative terminal. Further, the first-primary positive terminal may be connectable with the AC system. Further, the first-primary negative terminal may be connected with the second-primary positive terminal. Further, the second-primary negative terminal may be grounded. Further, the first H-bridge inverter may further comprise a first-secondary terminal comprising a first-secondary positive terminal and a first-secondary negative terminal. Further, the second H-bridge inverter may further comprise a second-secondary terminal comprising a second-secondary positive terminal and a second-secondary negative terminal. Further, the system may include a battery device. Further, the battery device includes two or more battery modules corresponding to the two or more H-bridge inverters. Further, the two or more battery modules include a first battery module and a second battery module. Further, the first battery module may comprise a first positive terminal and a first negative terminal. Further, the second battery module may comprise a second positive terminal and a second negative terminal. Further, the first positive terminal and the second positive terminal may be connected with the first-secondary positive terminal and the second-secondary positive terminal respectively. Further, the first negative terminal and the second negative terminal may be connected with the first-secondary negative terminal and the second-secondary negative terminal respectively. Further, each of the first-secondary terminal and the second-secondary terminal may be connected with the DC system.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a block diagram of the system of provisioning an interface between an AC system and a DC system, in accordance with some embodiments.

FIG. 4 is a block diagram of a system for facilitating interfacing of an AC system with a DC system, in accordance with some embodiments.

FIG. 5 is a block diagram of the system with the AC system and the DC system, in accordance with some embodiments.

FIG. 7 is a block diagram of the system, in accordance with some embodiments.

FIG. 8 is a schematic diagram of a system for interfacing a medium-voltage grid with a low voltage DC system.

FIG. 9 is a schematic diagram of a system for interfacing a medium-voltage grid with a low voltage DC system, in accordance with some embodiments.

FIG. 10 is a schematic diagram of the system, in accordance with some embodiments.

FIG. 11 is a schematic diagram of the system, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive.

Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure relates to a system of provisioning an interface between an AC system and a DC system. Further, the AC system may be an AC grid. Further, the system interfaces a medium-voltage grid with a low voltage battery or charger system. Further, the system includes a multi-level converter. Further, the system has batteries on the high voltage DC bus output of a multi-level Cascaded H-bridge converter of the system.

Further, the system may be an “n” module 3-phase system. Further, the “n” module 3-phase system has “3×n” battery packs placed on the high-side floating DC busses instead of having a single large battery pack on the low voltage side of the “n” module 3-phase system. Further, the placement of the 3×n” battery packs on the high-side floating DC busses instead of having a single large battery pack on the low voltage side of the “n” module 3-phase system, may result in a higher cost of insulation, however, battery management and balancing, stability of the converter, and reliability of the system will increase.

The system prevents the passing of full charging and discharging power of the batteries through the dual active bridge converters for interfacing the medium-voltage grid with the low voltage battery or charger system. Further, the grid-battery interface is done through the cascaded H-bridge inputs which also increases the efficiency during grid-level battery storage mode of operation. As a result, the sizing of dual-active bridge converters can be reduced to the amount needed for the low voltage system including a low voltage DC electric vehicle charger.

Further, the system may operate solely in ancillary service mode and grid-level battery storage when a low-side load such as an electric vehicle is not available by shutting down the dual-active bridge converters and reducing the power losses and cost of operation. Further, the utilization of multiple battery packs instead of a single large pack increases the reliability of the system as failure of one or two packs will not stop the system. The system can bypass the failed modules and continue operation using the remaining battery packs.

Further, the system allows the integration of insulation and cooling of the floating battery packs with the insulation of the cascaded H-bridge and each level's insulator-cooling liquid to reduce the overall cost. Further, the battery packs on the high side of the cascaded H-bridge/dual-active bridge converter increase the stability of the high-side DC link and will allow for low-loss switching patterns such as selected-harmonic-elimination without the challenges regarding dc-link regulation and balancing. Further, the system may include additional dedicated DC/DC converters that may be incorporated for each battery pack, if the battery packs have a different voltage range than the desired voltage range of the cascaded H-bridge.

Further, the present disclosure describes a system for interfacing a medium-voltage grid with a low voltage battery or charger system. Further, the system includes battery packs that are placed on the floating high-side DC link of a cascaded H-bridge of the system interfacing a medium-voltage AC input and before the isolated dual-active bridge converters that supply the low voltage side. Further, the dual-active bridge converters may be removed or bypassed if not needed. Further, the batteries may be any battery type such as Li-ion batteries, lead-acid batteries, flow batteries, etc. Each module may have a different type and/or capacity of battery. Further, each battery pack may be in series with optional DC-to-DC converters to match the range of the battery with the desired range of the DC-link. Further, the output of the battery may be connected to any isolated DC/DC converter to supply a low-side load such as an electric vehicle charger. Further, the number of modules and phases may be infinite.

The system may include uni-/bi-directional downstream converters from each H-bridge-battery module. Downstream converters may interface electric vehicle charger dispensers, solar strings, wind turbine converters, and/or low voltage inverters. The placement of batteries after the cascaded H-bridge back-ends will eliminate the need for electrolytic capacitors which will increase the expected life span of the converter. Further, the battery modules will be placed on insulated trays to enhance the original battery manufacturer's enclosure insulation rating of each battery to allow the batteries to be used in a medium voltage converter. The system may be fully or partially submerged in insulating coolant liquid. Each battery module may or may not include a dedicated isolating converter.

Battery modules may be from different battery technologies including but not limited to lead acid, lithium, or flow batteries. Batteries may include dedicated battery management systems per module or use a shared battery management system through optic fiber or wireless communication. Batteries on each module may have a dedicated dc-dc converter to regulate the voltage based on the state-of-charge or the H-bridge converter controller may regulate the dc voltage as a function of battery's state of charge.

Each module may use one or multiple strings of batteries. Battery capacity and string voltage on each module might be different than the rest of the modules. Film capacitors may be incorporated on each module to reduce the stress on each battery. Each module may be equipped with one or multiple bi-directional blocking switches equipped with suppressors to act as a solid-state circuit breaker. One or more modules may be bypassed due to a fault or for maintenance without disrupting the operation of the system.

The system may be placed in service as a single-phase line to neutral, single-phase line to line, or a multi-phase system. The system may be enclosed in a container for underground burial or overhead installations. The system may operate in grid-connected mode and/or grid-forming islanded mode. Multiple systems can be paralleled to increase capacity and/or reliability. Module and central controllers may be equipped with artificial intelligence and reinforcement learning algorithms to estimate the degradation, state-of-charge, voltage, temperature, failures of each battery or H-bridge converter and automatically execute proper action. Modules may have heaters for operation in cold climates.

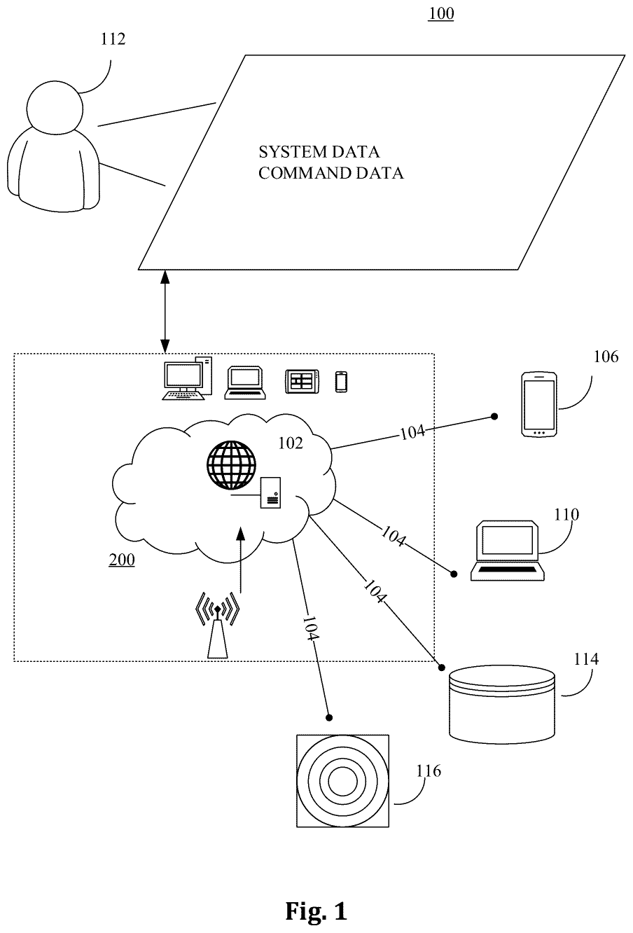

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

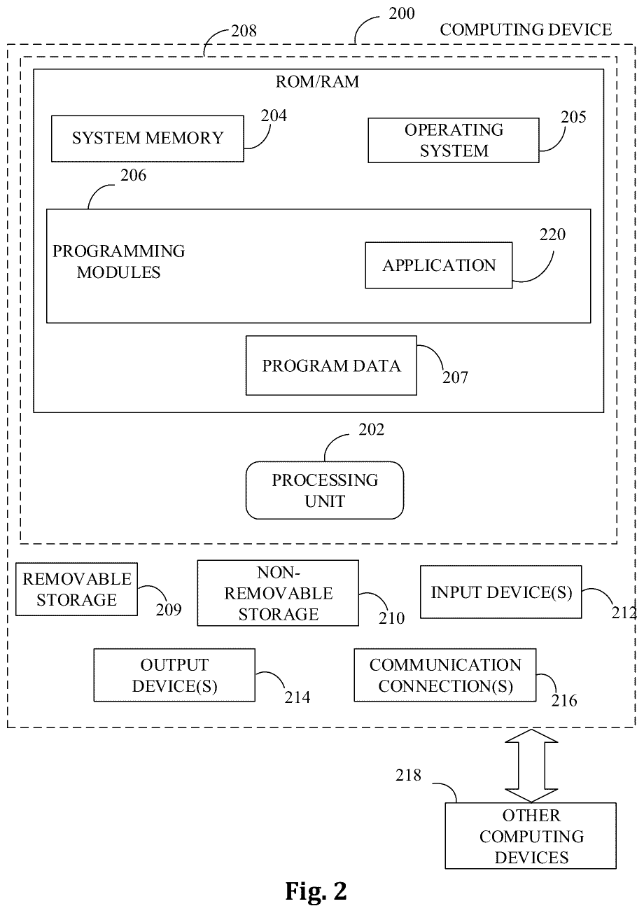

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

In some embodiments, the system may include an inverter device that includes two or more H-bridge inverters. Further, the two or more H-bridge inverters include first H-bridge inverter and a second H-bridge inverter. Further, the first H-bridge inverter may comprise a first-primary terminal comprising a first-primary positive terminal and a first-primary negative terminal. Further, the second H-bridge inverter may comprise a second-primary terminal comprising a second-primary positive terminal and a second-primary negative terminal. Further, the first-primary positive terminal may be connectable with the AC system. Further, the first-primary negative terminal may be connected with the second-primary positive terminal. Further, the second-primary negative terminal may be grounded. Further, the first H-bridge inverter may further comprise a first-secondary terminal comprising a first-secondary positive terminal and a first-secondary negative terminal. Further, the second H-bridge inverter may be further associated with a second-secondary terminal comprising a second-secondary positive terminal and a second-secondary negative terminal. Further, the system may include a battery device that includes two or more battery modules corresponding to the two or more H-bridge inverters. Further, the two or more battery modules include a first battery module and a second battery module. Further, the first battery module may comprise a first positive terminal and a first negative terminal. Further, the second battery module may comprise a second positive terminal and a second negative terminal. Further, the first positive terminal and the second positive terminal may be connected with the first-secondary positive terminal and the second-secondary positive terminal respectively. Further, the first negative terminal and the second negative terminal may be connected with the first-secondary negative terminal and the second-secondary negative terminal respectively. Further, each of the first-secondary terminal and the second-secondary terminal may be further connected with the DC system.

Further, in some embodiments, the two or more H-bridge inverters may be configured for receiving an AC power from the AC system through the first-primary positive terminal. Further, the AC system may be associated with the AC power. Further, the two or more H-bridge inverters may be configured for converting the AC power into a DC power. Further, the two or more H-bridge inverters may be configured for transmitting the DC power to one or more of the two or more battery modules and the DC system through one or more of the first-secondary terminal and the second-secondary terminal.

Further, in some embodiments, the two or more battery modules may be configured for storing the DC power based on charging of two or more batteries. Further, the two or more battery modules include the two or more batteries. Further, the two or more battery modules may be configured for transmitting the DC power to the DC system through one or more of the first-secondary terminal and the second-secondary terminal connected with the first battery module and the second battery module respectively. Further, the transmitting of the DC power to the DC system may be based on discharging of the two or more batteries.

Further, in some embodiments, the two or more H-bridge inverters may be configured for receiving a DC power from one or more of the two or more battery modules and the DC system through one or more of the first-secondary terminal and the second-secondary terminal. Further, the DC system may be associated with the DC power. Further, the two or more H-bridge inverters may be configured for converting the DC power into an AC power. Further, the two or more H-bridge inverters may be configured for transmitting the AC power to the AC system through the first-primary positive terminal.

Further, in some embodiments, the two or more battery modules may be configured for receiving the DC power from the DC system through one or more of the first-secondary terminal and the second-secondary terminal connected with the first battery and the second battery respectively. Further, the two or more battery modules may be configured for storing the DC power based on charging of two or more batteries. Further, the two or more battery modules include the two or more batteries. Further, the two or more battery modules may be configured for transmitting the DC power to the two or more H-bridge inverters through one or more of the first-secondary terminal and the second-secondary terminal connected with the first battery module and the second battery module respectively. Further, the transmitting of the DC power to the two or more H-bridge inverters may be based on discharging of the two or more batteries.

In some embodiments, the system may further include a converter device comprising two or more dual-active bridge converters. Further, the two or more dual-active bridge converters include a first converter and a second converter. Further, the first converter may comprise a first-converter primary terminal comprising a first-converter primary positive terminal and a first-converter primary negative terminal. Further, the first-converter primary positive terminal and the first-converter primary negative terminal may be connected with the first-secondary positive terminal and the first-secondary negative terminal respectively. Further, the second converter may comprise a second-converter primary terminal comprising a second-converter primary positive terminal and a second-converter primary negative terminal. Further, the second-converter primary positive terminal and the second-converter primary negative terminal may be connected with the second-secondary positive terminal and the second-secondary negative terminal respectively.

In some embodiments, the first converter and the second converter may further comprise a first-converter secondary terminal and a second-converter secondary terminal respectively. Further, the first-converter secondary terminal includes a first-converter secondary positive terminal and a first-converter secondary negative terminal. Further, the second-converter secondary terminal includes a second-converter secondary positive terminal and a second-converter secondary negative terminal. Further, the second-converter secondary positive terminal and the second-converter secondary negative terminal may be connected with the first-converter secondary positive terminal and the first-converter secondary negative terminal respectively, may. Further, each of the first-converter secondary positive terminal and the first-converter secondary negative may be further connectable with the DC system.

Further, in some embodiments, the two or more dual-active bridge converters may be configured for receiving the DC power from one or more of the two or more H-bridge inverters and the two or more battery modules through one or more of the first-converter primary terminal and the second-converter primary terminal. Further, the DC power may be characterized by a first voltage. Further, the two or more dual-active bridge converters may be configured for converting the DC power with the first voltage to a second DC power. Further, the second DC power may be characterized by a second voltage. Further, the first voltage may be greater than second voltage. Further, the two or more dual-active bridge converters may be configured for transmitting the second DC power to the DC system through one or more of the first-converter secondary terminal and the second-converter secondary terminal.

Further, in some embodiments, the two or more dual-active bridge converters may be configured for receiving a second DC power from the DC system through one or more of the first-converter secondary terminal and the second-converter secondary terminal. Further, the second DC power may be characterized by a second voltage. Further, the two or more dual-active bridge converters may be configured for converting the second DC power with the second voltage to the DC power, may. Further, the DC power may be characterized by a first voltage. Further, the two or more dual-active bridge converters may be configured for transmitting the DC power to one or more of the two or more H-bridge inverters and the two or more battery modules through one or more of the first-converter primary terminal and the second-converter primary terminal.

In some embodiments, the two or more battery modules include two or more batteries. Further, the two or more batteries may be characterized by two or more battery characteristics. Further, one of the two or more battery characteristics corresponds to a battery voltage. Further, the two or more H-bridges may be characterized by with two or more inverter characteristics. Further, one of the two or more inverter characteristics corresponds to a H-bridge voltage.

In some embodiments, the system may further include two or more additional converters corresponding to the two or more battery modules. Further, the two or more additional-converters include a first additional-converter and a second additional-converter. Further, the first additional-converter may comprise a first additional-converter first terminal and a first additional-converter second terminal. Further, the first additional-converter first terminal and the first additional-converter second terminal may be connected with the first-secondary positive terminal and the first positive terminal respectively.

In some embodiments, the second additional-converter may comprise a second additional-converter first terminal and a second additional-converter second terminal. Further, the second additional-converter first terminal and the second additional-converter second terminal may be connected with the second-secondary positive terminal and the second positive terminal respectively.

Further, in some embodiments, the two or more additional-converters may be configured for receiving a DC power from the two or more H-bridge inverters through one or more of the first additional-converter first terminal and the second additional-converter first terminal. Further, the DC power may be characterized by the H-bridge voltage. Further, the two or more additional-converters may be configured for converting the DC power with the H-bridge voltage to a battery voltage DC power, may. Further, the battery voltage DC power may be characterized by the battery voltage. Further, the two or more additional-converters may be configured for transmitting the battery voltage DC power to one or more of the two or more battery modules through one or more of the first additional-converter second terminal and the second additional-converter second terminal.

Further, in some embodiments, the two or more additional converters may be configured for receiving battery voltage DC power from the two or more battery modules through one or more of the first additional-converter second terminal and the second additional-converter second terminal. Further, the battery voltage DC power may be characterized by the battery voltage. Further, the two or more additional converters may be configured for converting the battery voltage DC power to a DC power. Further, the DC power may be characterized by the H-bridge voltage. Further, the two or more additional converters may be configured for transmitting the DC power to the two or more H-bridge inverters through one or more of the first additional-converter first terminal and the second additional-converter first terminal.

In some embodiments, the H-bridge voltage may be different from the battery voltage.

In some embodiments, the two or more additional-converters correspond to a DC-DC converter.

In some embodiments, each of the two or more battery modules includes one or more batteries.

In some embodiments, the one or more batteries correspond to one or more of a Li-ion battery, lead-acid battery and a flow battery.

In some embodiments, the AC system corresponds to a grid. Further, the grid may be an interconnected network which may be configured for transmitting electricity.

In some embodiments, the two or more H-bridge inverters corresponds to a cascaded H-bridge inverter.

In some embodiments, the AC system corresponds to a three-phase system.

In some embodiments, the AC power may be associated with a voltage. Further, the range of the voltage corresponds to a medium voltage level.

In some embodiments, the medium voltage level corresponds to the voltage ranges from 1 kV to 35 kV.

In some embodiments, the AC system corresponds to a medium voltage grid.

In some embodiments, the AC system corresponds to an alternating current system, may. Further, the DC system corresponds to a direct current system.

In some embodiments, the two or more H-bridge inverters correspond to an AC to DC converter.

In some embodiments, the DC system corresponds to an electric vehicle charger.

In some embodiments, the DC system corresponds to a solar string. Further, the solar string corresponds to two or more solar panels connected in series.

In some embodiments, the DC system corresponds to a wind turbine converter.

In some embodiments, the DC system corresponds to a low voltage inverter.

In some embodiments, each of the two or more batteries corresponds to the two or more H-bridge inverters including three batteries.

In some embodiments, the two or more additional-converters corresponds to a downstream converter.

In some embodiments, the downstream converter corresponds to one or more of a unidirectional downstream converter and a bidirectional downstream converter.

In some embodiments, the unidirectional downstream converter allows DC power to flow in one direction.

In some embodiments, the unidirectional downstream converter allows DC power to flow in two directions.

In some embodiments, the battery voltage may be based on the two or more battery characteristics.

In some embodiments, the two or more battery characteristics may be based on a technology of the two or more batteries.

In some embodiments, the two or more battery modules corresponding to the two or more H-bridge inverters may be based on two or more technologies.

In some embodiments, the first battery module may be based on a first technology corresponding to a first battery characteristics. Further, the second battery module may be based on a second technology corresponding to the second battery characteristics.

In some embodiments, the two or more battery characteristics correspond to one or more of a battery type and a battery capacity.

In some embodiments, the two or more battery modules include two or more batteries. Further, the two or more batteries may be placed on two or more insulated trays. Further, each of the two or more insulated trays may be made up of an insulating material for insulating the two or more batteries.

In some embodiments, the system may be placed in an insulating-cooling liquid.

In some embodiments, the system may be fully submerged in the insulating-cooling liquid.

In some embodiments, the system may be partially submerged in the insulating-cooling liquid.

In some embodiments, the insulating-cooling liquid may be configured to insulate and cool the system.

In some embodiments, each of the two or more battery modules includes two or more batteries.

In some embodiments, the two or more battery characteristics correspond to a string voltage of two or more batteries in the two or more battery modules.

In some embodiments, each of the two or more battery modules may be associated with a film capacitor. Further, the film capacitor includes an insulating film between two conductive layers.

In some embodiments, the film capacitor reduces the stress on two or more batteries of the two or more battery modules.

In some embodiments, the two or more H-bridge inverters may be associated with a bi-directional blocking switch. Further, the bi-directional blocking switch may be further associated with a suppressor component to act as a solid-state circuit breaker.

In some embodiments, the bi-directional blocking switch may be configured to block a flow of DC power in two directions in relation to the two or more H-bridge inverters. Further, the block may be based on a state of the bi-directional blocking switch. Further, the bi-directional blocking switch may be associated with two states comprising the state.

In some embodiments, the suppressor component may be configured to prevent one or more of an electrical surge, a transient and a voltage spike.

In some embodiments, the electrical surge corresponds to an overvoltage condition.

In some embodiments, the transient corresponds to a voltage spike. Further, the voltage spike last for short duration of time.

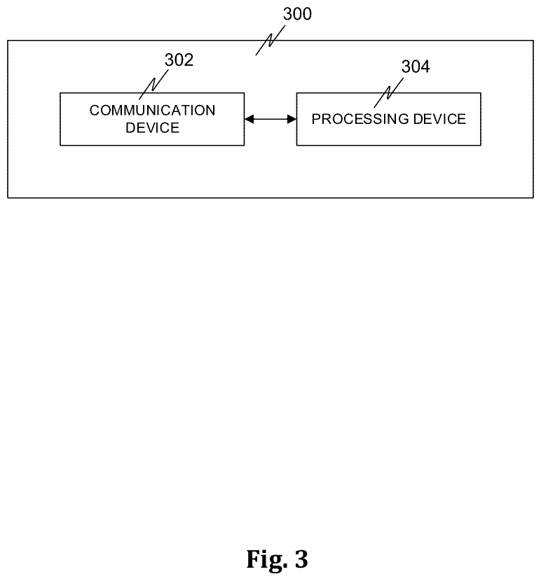

FIG. 3 illustrates a block diagram of the system of provisioning an interface between an AC and a DC, in accordance with some embodiments.

Further, in some embodiments, the system may be associated with a battery management system 300. Further, the battery management system 300 may include a communication device 302. Further, the communication device 302 may be configured for receiving a system data from the system. Further, the system data corresponds to one or more of the system. Further, the communication device 302 may be configured for transmitting a command data to a controller device. Further, the system may be associated with the controller device. Further, the battery management system 300 may include a processing device 304. Further, the processing device 304 may be configured for generating the command data based on the system data. Further, the generating may be based on an AI model. Further, the command data corresponds to a command.

In some embodiments, the controller device may be configured to regulate a voltage of a DC power from one or more of the two or more H-bridge inverters based on the command. Further, the command corresponds to the voltage of the DC power.

In some embodiments, the system data corresponds to a state of charge of one or more of the two or more battery modules. Further, the state of charge corresponds to an amount of electric charge stored in one or more of the two or more battery modules in relation to a total capacity of the one or more of the two or more battery modules.

Further, the one or more of the two or more H-bridge inverters may be associated with the one or more of the two or more battery modules.

In some embodiments, the two or more battery modules may be associated with two or more DC-DC converters. Further, the controller device may be configured to regulate a voltage of DC power from one or more of the two or more DC-DC converters based on the command. Further, the command corresponds to the voltage of DC power.

In some embodiments, the system data corresponds to a state of charge of one or more of the two or more battery modules. Further, the state of charge corresponds to an amount of electric charge stored in one or more of the two or more battery modules in relation to a total capacity of the one or more of the two or more battery modules.

Further, the one or more of the two or more DC-DC converters may be associated with the one or more of the two or more battery modules.

In some embodiments, the AC system corresponds to a single-phase line to neutral system.

In some embodiments, the AC system corresponds to a single-phase line to line system.

In some embodiments, the AC system corresponds to a multi-phase system.

In some embodiments, the system may be associated with one or more of a grid-connected mode and a grid-forming islanded mode.

In some embodiments, the AI model may be based on reinforcement learning algorithm.

In some embodiments, the system data corresponds to one or more of a voltage of a DC power, a temperature of the system, a failure of one or more of the two or more H-bridge inverters, a state of charge of one or more of the two or more battery modules and a failure of one or more of the two or more battery modules.

In some embodiments, the system may be associated with a heater. Further, the heater may be configured to maintain the system in a particular range of temperature based on a temperature of an environment. Further, the system may be associated with the environment.

In some embodiments, each of the two or more battery modules includes three batteries.

In some embodiments, the system may be associated with an ancillary service mode based on an availability of the DC system.

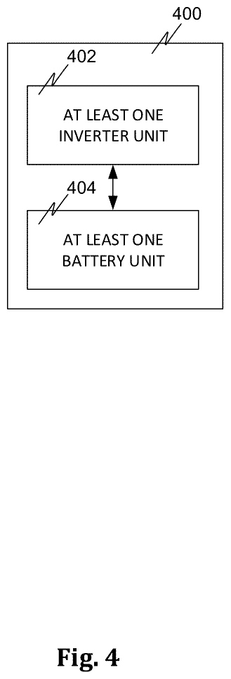

FIG. 4 is a block diagram of a system for facilitating interfacing of an AC system with a DC system, in accordance with some embodiments. Further, the system may include an “n” module 3-phase system. Further, the AC system may include at least one phase conductor corresponding to at least one phase associated with the AC system. Further, the AC system may include an AC grid.

Further, the system may include at least one inverter unit corresponding to the at least one phase conductor. Further, each of the at least one inverter unit may be connected to each of the at least one phase conductor corresponding to each of the at least one inverter unit. Further, each of the at least one inverter unit may include a number of H-bridge inverters. Further, each of the number of H-bridge inverters may be an H-bridge unit, an AC-DC inverter, etc. Further, each of the number of H-bridge inverters may facilitate either a unidirectional power flow or a bidirectional power flow. Further, the number of H-bridge inverters may be connected in a cascading manner. Further, the number of H-bridge inverters may be a number of cascaded H-bridge inverters. Further, the connecting of the number of H-bridge inverters in the cascading manner provides two primary terminals for each of the at least one inverter unit. Further, two primary terminals may include a first primary terminal and a second primary terminal. Further, the first primary terminal of each of the at least one inverter unit may be connected to each of the at least one phase conductor corresponding to each of the at least one inverter unit. Further, the second primary terminal of each of the at least one inverter unit may be grounded. Further, each of the number of H-bridge inverters may include two secondary terminals. Further, the two secondary terminals include a first secondary terminal and a second secondary terminal. Further, the number of H-bridge inverters converts AC power received from the AC system on the first primary terminals of the number of H-bridge inverters to DC power and supplies the DC power through the two secondary terminals of each of the number of H-bridge inverters. Further, in an embodiment, the number of H-bridge inverters converts the DC power received through the two secondary terminals of each of the number of H-bridge inverters, to the AC power and supplies the AC power through the first primary terminal to the AC system.

Further, the system may include at least one battery unit. Further, each of the at least one battery unit corresponds to each of the at least one inverter unit. Further, each of the at least one battery unit may include a number of batteries. Further, each of the number of batteries of each of the at least one battery unit may be connected to each of the number H-bridge inverters of each of the at least one inverter unit. Further, each of the number of batteries may include two terminals comprising a first terminal and a second terminal. Further, the first terminal of each of the number of batteries may be connected to the first secondary terminal of each of the number of H-bridge inverters corresponding to each of the number of batteries and the second terminal of each of the number of batteries may be connected to the second secondary terminal of each of the number of H-bridge inverters corresponding to each of the number of batteries. Further, each of the number of batteries receives the DC power through the two terminals from the two secondary terminals of each of the number of H-bridge inverters. Further, in an embodiment, each of the number of batteries supplies the DC power through the two terminals to the two secondary terminals of each of the number of H-bridge inverters. Further, in an embodiment, each of the number of batteries stores the DC power based on the receiving of the DC power by charging the each of the number of batteries. Further, in an embodiment, each of the number of batteries provides the DC power based on the supplying of the DC power by discharging the each of the number of batteries. Further, in an embodiment, the two secondary terminals of at least one of the number of H-bridge inverters connected with the two terminals of at least one of the number of batteries may be connected in a parallel connection to the DC system. Further, the two secondary terminals of at least one of the number of H-bridge inverters connected with the two terminals of at least one of the number of batteries may supply the DC power to the DC system. Further, in an embodiment, the DC system supplies the DC power to at least one of the number of H-bridge inverters and at least one of the number of batteries through the two secondary terminals of at least one of the number of H-bridge inverters connected with the two terminals of at least one of the number of batteries.

Further, in some embodiments, the AC power of the AC system may be associated with a voltage. Further, the voltage ranges from 1 kV (kilovolts) to 52 kV. Further, the AC system may be a medium voltage grid. Further, in an embodiment, the voltage ranges from 2.4 kV to 34.5 kV.

Further, in some embodiments, the AC system may be a 3-phase AC grid. Further, the at least one phase conductor may include three phase conductors. Further, the at least one inverter unit may include three inverter units and the at least one battery unit may include three battery units. Further, the three inverter units along with the three battery units may separately interface the DC system with the AC system. Further, in an embodiment, the DC system may include three DC systems. Further, each of the three inverter units along with each of the three battery units may separately interface the three DC systems with the AC system. Further, in an embodiment, the three inverter units along with the three battery units may combinedly interface the DC system with the AC system.

Further, in some embodiments, the system may include at least one converter unit. Further, each of the at least one converter unit corresponds to each of the at least one battery unit. Further, each of the at least one converter unit may include a number of dual-active bridge converters. Further, each of the number of dual-active bridge converters of each of the at least one converter unit may correspond to each of the number of batteries of each of the at least one battery unit. Further, each of the number of dual-active bridge converters may be a DC-DC converter. Further, each of the number of dual-active bridge converters may include two primary terminals comprising a first primary terminal and a second primary terminal. Further, the two primary terminals of each of the number of dual-active bridge converters may be connected to the two secondary terminals of at least one of the number of H-bridge inverters connected with the two terminals of each of the number of batteries corresponding to each of the number of dual-active bridge converters. Further, each of the number of dual-active bridge converters may include two secondary terminals comprising a first secondary terminal and a second secondary terminal. Further, each of the number of dual-active bridge converters may receive the DC power of a first voltage through the two primary terminals from the two secondary terminals of at least one of the number of H-bridge inverters connected with the two terminals of each of the number of batteries and converts the DC power of the first voltage to DC power of a second voltage and supplies the DC power of the second voltage through the two secondary terminals of each of the number of dual-active bridge converters. Further, the first voltage may be higher than the second voltage. Further, the two secondary terminals of at least one of the number of dual-active bridge converters may be parallelly connected to the DC system. Further, in an embodiment, each of the number of dual-active bridge converters may receive the DC power of the second voltage through the two secondary terminals of each of the number of dual-active bridge converters from the DC system and convert the DC power of the second voltage to the DC power of the first voltage and supplies the DC power of the first voltage through the two primary terminals of each of the number of dual-active bridge converters to the two secondary terminals of at least one of the number of H-bridge inverters connected with the two terminals of each of the number of batteries. Further, in an embodiment, the DC system may include at least one external battery, a DC charger, a DC load, etc.

Further, in some embodiments, at least one of the number of batteries of the at least one battery unit may be associated with at least one battery characteristic. Further, the at least one battery characteristic may include a battery type, a battery capacity, etc. Further, the at least one battery characteristic defines a battery voltage of each of the number of batteries. Further, the number of batteries may include Li-ion batteries, lead-acid batteries, flow batteries, etc.

Further, in some embodiments, each of the number of batteries may be associated with a battery voltage. Further, the system may include at least one additional converter unit. Further, each of the at least one additional converter unit corresponds to each of the at least one battery unit. Further, the at least one additional converter unit may include a number of DC-DC converters corresponding to the number of batteries of each of the at least one battery unit. Further, each of the number of DC-DC converters may include a primary terminal and a secondary terminal. Further, the secondary terminal of each of the number of DC-DC converters may be connected to the first terminal of each of the number of batteries corresponding to each of the number of DC-DC converters. Further, the primary terminal of each of the number of DC-DC converters may be connected to the first secondary terminal of each of the number of H-bridge inverters corresponding to each of the number of batteries. Further, the each of the number of DC-DC converters may be configured for performing at least one DC-DC power conversion for matching the battery voltage with the first voltage of the DC power. Further, the receiving of the DC power of the first voltage by each of the number of batteries may be based on the matching. Further, in an embodiment, the supplying of the DC power of the first voltage by each of the number of batteries may be based on the matching.

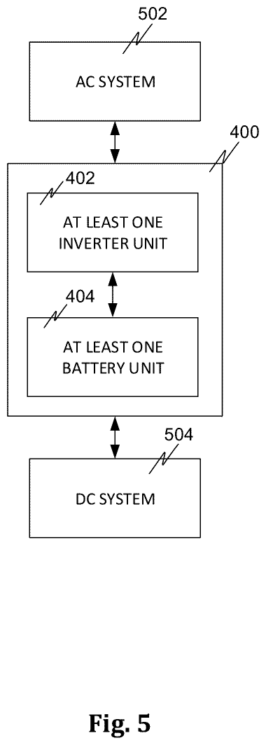

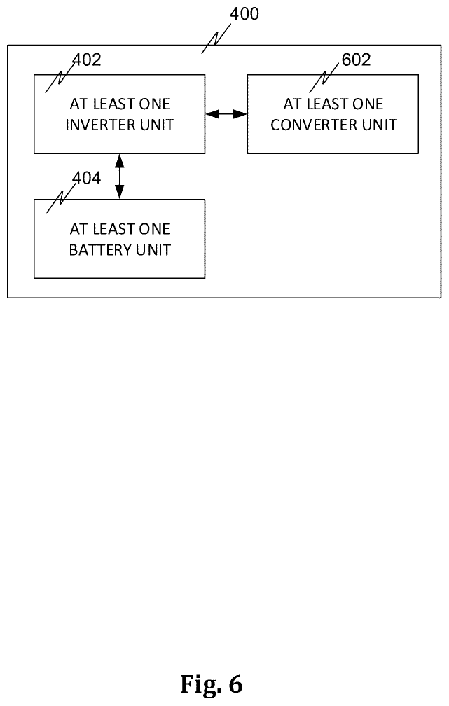

FIG. 5 is a block diagram of the system with the AC system and the DC system, in accordance with some embodiments.

FIG. 6 is a block diagram of the system, in accordance with some embodiments.

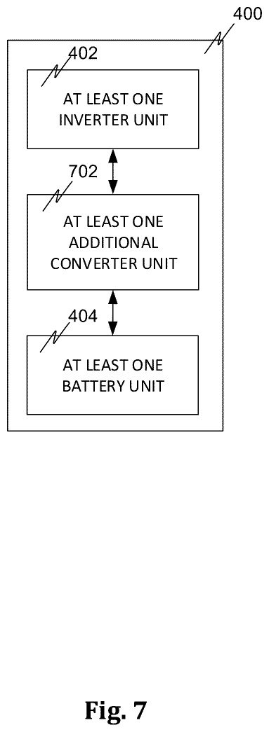

FIG. 7 is a block diagram of the system, in accordance with some embodiments.

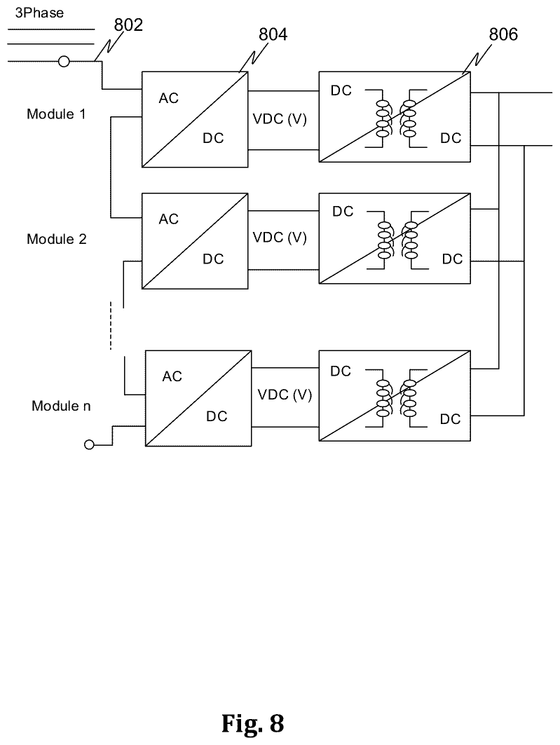

FIG. 8 is a schematic diagram of a system for interfacing a medium-voltage grid with a low voltage DC system. Further, the system may include cascaded H-bridge inverters that have been combined with dual-active bridge isolated DC-DC converters to interface the medium-voltage grid with a low voltage battery or charger system. Further, the system may include “n” modules of H-bridge/dual-active bridge converters. Further, the “n” modules of H-bridge/dual-active bridge converters are placed in series on the medium voltage side and in parallel on a low voltage side. Further, batteries placed on the low voltage side may be connected to the medium-voltage grid.

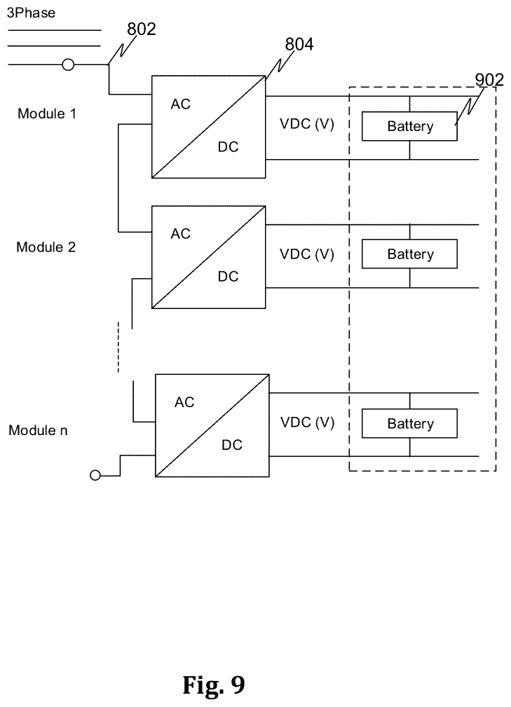

FIG. 9 is a schematic diagram of a system for interfacing a medium-voltage grid with a low voltage DC system, in accordance with some embodiments. Further, the system may include a multi-level Cascaded H-bridge converter with high voltage DC buses and batteries placed on the high voltage DC buses. Further, the system may be an “n” module 3-phase system.

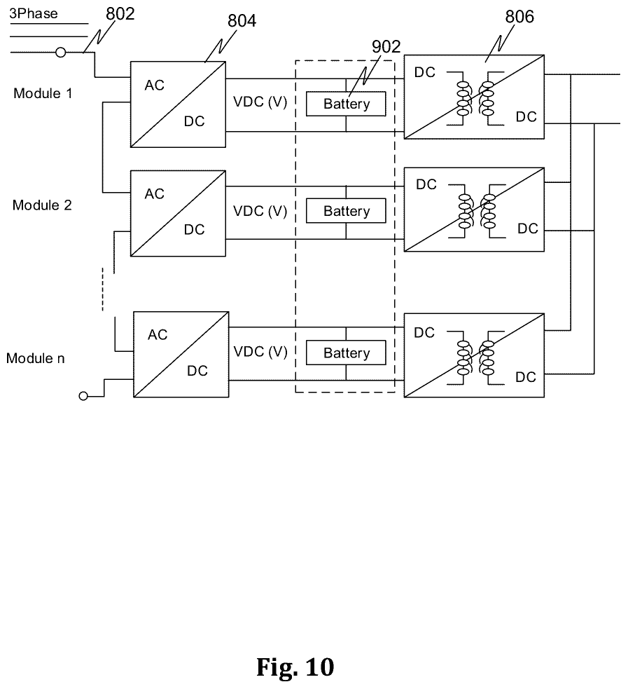

FIG. 10 is a schematic diagram of the system, in accordance with some embodiments. Further, the system may include dual-active bridge converters placed after the batteries and supply the low voltage side. Further, the dual-active bridge converters may be removed or bypassed if not needed.

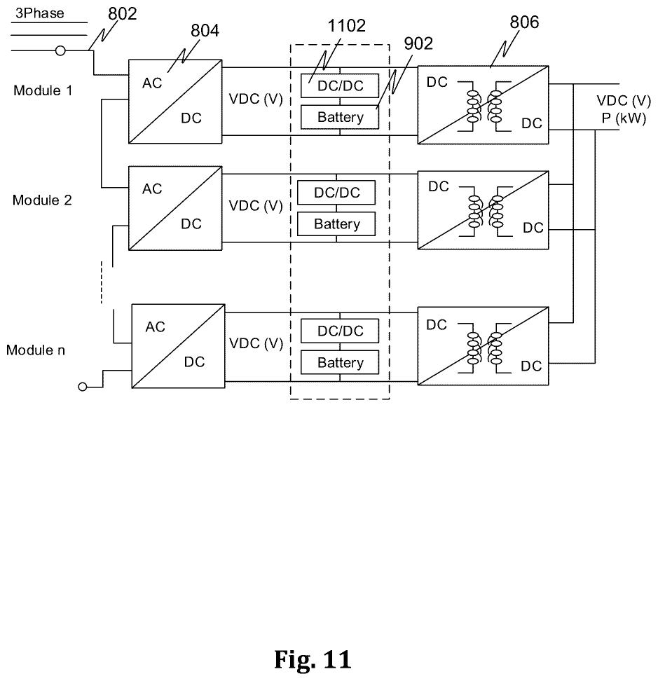

FIG. 11 is a schematic diagram of the system, in accordance with some embodiments. Further, the system may include additional dedicated DC/DC converters incorporated in the batteries.

Although the invention has been explained in relation to its preferred embodiment, it is to be understood that many other possible modifications and variations can be made without departing from the spirit and scope of the invention as hereinafter claimed.

1. A system of provisioning an interface between an AC system and a DC system, the system comprising:
an inverter device comprising a plurality of H-bridge inverters, wherein the plurality of H-bridge inverters comprises a first H-bridge inverter and a second H-bridge inverter, wherein the first H-bridge inverter comprises a first-primary terminal comprising a first-primary positive terminal and a first-primary negative terminal, wherein the second H-bridge inverter comprises a second-primary terminal comprising a second-primary positive terminal and a second-primary negative terminal, wherein the first-primary positive terminal is connectable with the AC system, wherein the first-primary negative terminal is connected with the second-primary positive terminal, wherein the second-primary negative terminal is grounded, wherein the first H-bridge inverter further comprises a first-secondary terminal comprising a first-secondary positive terminal and a first-secondary negative terminal, wherein the second H-bridge inverter further comprises a second-secondary terminal comprising a second-secondary positive terminal and a second-secondary negative terminal; and
a battery device comprising a plurality of battery modules corresponding to the plurality of H-bridge inverters, wherein the plurality of battery modules comprises a first battery module and a second battery module, wherein the first battery module comprises a first positive terminal and a first negative terminal, wherein the second battery module comprises a second positive terminal and a second negative terminal, wherein the first positive terminal and the second positive terminal is connected with the first-secondary positive terminal and the second-secondary positive terminal respectively, wherein the first negative terminal and the second negative terminal is connected with the first-secondary negative terminal and the second-secondary negative terminal respectively, wherein each of the first-secondary terminals and the second-secondary terminals is further connected with the DC system.

2. The system of claim 1, wherein the plurality of H-bridge inverters is configured for:
receiving an AC power from the AC system through the first-primary positive terminal, wherein the AC system is associated with the AC power;
converting the AC power into a DC power; and
transmitting the DC power to at least one of the plurality of battery modules and the DC system through at least one of the first-secondary terminal and the second-secondary terminal.

3. The system of claim 2, wherein the plurality of battery modules is configured for:
storing the DC power based on charging of a plurality of batteries, wherein the plurality of battery modules comprises the plurality of batteries; and
transmitting the DC power to the DC system through at least one of the first-secondary terminal and the second-secondary terminal connected with the first battery module and the second battery module respectively, wherein the transmitting of the DC power to the DC system is based on discharging of the plurality of batteries.

4. The system of claim 1, wherein the plurality of H-bridge inverters is configured for:
receiving a DC power from at least one of the plurality of battery modules and the DC system through at least one of the first-secondary terminal and the second-secondary terminal, wherein the DC system is associated with the DC power;
converting the DC power into an AC power; and
transmitting the AC power to the AC system through the first-primary positive terminal.

5. The system of claim 4, wherein the plurality of battery module is configured for:
receiving the DC power from the DC system through at least one of the first-secondary terminal and the second-secondary terminal connected with the first battery and the second battery respectively;
storing the DC power based on charging of a plurality of batteries, wherein the plurality of battery modules comprises the plurality of batteries; and
transmitting the DC power to the plurality of H-bridge inverters through at least one of the first-secondary terminal and the second-secondary terminal connected with the first battery module and the second battery module respectively, wherein the transmitting of the DC power to the plurality of H-bridge inverters is based on discharging of the plurality of batteries.

6. The system of claim 1 further comprises a converter device comprising a plurality of dual-active bridge converters, wherein the plurality of dual-active bridge converters comprises a first converter and a second converter, wherein the first converter comprises a first-converter primary terminal comprising a first-converter primary positive terminal and a first-converter primary negative terminal, wherein the first-converter primary positive terminal and the first-converter primary negative terminal is connected with the first-secondary positive terminal and the first-secondary negative terminal respectively, wherein the second converter comprises a second-converter primary terminal comprising a second-converter primary positive terminal and a second-converter primary negative terminal, wherein the second-converter primary positive terminal and the second-converter primary negative terminal is connected with the second-secondary positive terminal and the second-secondary negative terminal respectively.

7. The system of claim 6, wherein the first converter and the second converter further comprises a first-converter secondary terminal and a second-converter secondary terminal respectively, wherein the first-converter secondary terminal comprises a first-converter secondary positive terminal and a first-converter secondary negative terminal, wherein the second-converter secondary terminal comprises a second-converter secondary positive terminal and a second-converter secondary negative terminal, wherein the second-converter secondary positive terminal and the second-converter secondary negative terminal is connected with the first-converter secondary positive terminal and the first-converter secondary negative terminal respectively, wherein each of the first-converter secondary positive terminal and the first-converter secondary negative is further connectable with the DC system.

8. The system of claim 7, wherein the plurality of dual-active bridge converters is configured for:
receiving the DC power from at least one of the plurality of H-bridge inverters and the plurality of battery modules through at least one of the first-converter primary terminal and the second-converter primary terminal, wherein the DC power is associated with a first voltage;
converting the DC power with the first voltage to a second DC power, wherein the second DC power is associated with a second voltage, wherein the first voltage is greater than second voltage; and
transmitting the second DC power to the DC system through at least one of the first-converter secondary terminal and the second-converter secondary terminal.

9. The system of claim 7, wherein the plurality of dual-active bridge converters is configured for:
receiving a second DC power from the DC system through at least one of the first-converter secondary terminal and the second-converter secondary terminal, wherein the second DC power is associated with a second voltage;
converting the second DC power with the second voltage to the DC power, wherein the DC power is associated with a first voltage; and
transmitting the DC power to at least one of the plurality of H-bridge inverters and the plurality of battery modules through at least one of the first-converter primary terminal and the second-converter primary terminal.

10. The system of claim 1, wherein the plurality of battery modules comprises a plurality of batteries, wherein the plurality of batteries is characterized by a plurality of battery characteristics, wherein one of the plurality of battery characteristics corresponds to a battery voltage, wherein the plurality of H-bridge inverters is characterized by a plurality of inverter characteristics, wherein one of the plurality of inverter characteristics corresponds to a H-bridge voltage.

11. The system of claim 10 further comprises a plurality of additional-converters corresponding to the plurality of battery modules, wherein the plurality of additional-converters comprises a first additional-converter and a second additional-converter, wherein the first additional-converter comprises a first additional-converter first terminal and a first additional-converter second terminal, wherein the first additional-converter first terminal and the first additional-converter second terminal is connected with the first-secondary positive terminal and the first positive terminal respectively.

12. The system of claim 11, wherein the second additional-converter comprises a second additional-converter first terminal and a second additional-converter second terminal, wherein the second additional-converter first terminal and the second additional-converter second terminal is connected with the second-secondary positive terminal and the second positive terminal respectively.

13. The system of claim 11, wherein the plurality of additional-converters is configured for:
receiving a DC power from the plurality of H-bridge inverters through at least one of the first additional-converter first terminal and the second additional-converter first terminal, wherein the DC power is characterized by the H-bridge voltage;
converting the DC power with the H-bridge voltage to a battery voltage DC power, wherein the battery voltage DC power is characterized by the battery voltage; and
transmitting the battery voltage DC power to at least one of the plurality of battery modules through at least one of the first additional-converter second terminal and the second additional-converter second terminal.

14. The system of claim 11, wherein the plurality of additional converters is configured for:
receiving a battery voltage DC power from the plurality of battery modules through at least one of the first additional-converter second terminal and the second additional-converter second terminal, wherein the battery voltage DC power is characterized by the battery voltage;
converting the battery voltage DC power to a DC power, wherein the DC power is characterized by the H-bridge voltage; and
transmitting the DC power to the plurality of H-bridge inverters through at least one of the first additional-converter first terminal and the second additional-converter first terminal.

15. The system of claim 11, wherein the H-bridge voltage is different from the battery voltage.

16. The system of claim 11, wherein the plurality of additional-converters corresponds to a DC-DC converter.

17. The system of claim 1, wherein each of the plurality of battery modules comprises at least one battery.

18. The system of claim 17, wherein the at least one battery corresponds to at least one of a Li-ion battery, lead-acid battery and a flow battery.

19. The system of claim 1, wherein the AC system corresponds to a grid, wherein the grid is an interconnected network configured for transmitting an electricity.

20. The system of claim 1, wherein the plurality of H-bridge inverters corresponds to a cascaded H-bridge inverter.
